(19) United States
(12) Patent Application Publication
(10) Pub. No.: US 2022/0092097 A1
(43) Pub. Date: Mar. 24, 2022

(54) Method for Extracting and Organizing Information from a Document

(71) Applicant: Anurag Gupta, Allen, TX (US)

(72) Inventor: Anurag Gupta, Allen, TX (US)

(21) Appl. No.: 17/478,093

(22) Filed: Sep. 17, 2021

Related U.S. Application Data
(60) Provisional application No. 63/080,454, filed on Sep. 18, 2020.

(51) Int. Cl. G06F 16/33; G06F 40/205; G06F 40/137; G06K 9/00

(52) U.S. Cl. CPC G06F 16/3344; G06K 9/00469; G06F 40/137; G06F 40/205

(57) ABSTRACT

A method extracts and organizes information from a document. A computing system is provided for extracting and organizing information from a document. A plurality of documents is stored onto or accessed through the computing system. With the computing system, a specific document can be selected from the plurality of documents. The computing system parses through the specific document in order to identify a plurality of linguistically-important texts. The computing system generates a plurality of outline headings from the linguistically-important texts. The computing system compiles the outline headings into a document outline for the specific document. The computing system then outputs the specific document and the document outline.

The current application claims a priority to the U.S. Provisional Patent application Ser. No. 63/080,454 filed on Sep. 18, 2020.

### FIELD OF THE INVENTION

The present invention relates generally to natural language processing (NLP) models. More specifically, the present invention is a system and method for extracting and organizing information from a document.

### BACKGROUND OF THE INVENTION

Digitalization of documents has been a growing industry in recent times. Significant investments have been made in digitizing business processes across industries to improve customer experience and usability of various products and services. Consumers and front-office employees have been a huge beneficiary of these investments. However, the back-office business processes have been left waiting. This is true even more in commercial transactions where, unlike retail transaction, the nature of documentation is highly customized and unstructured/semi-structured with minimal similarity between documentation from one vendor/customer/external party to another. The current state of document digitization stops at scanning of documents into portable document format or images and storing them in electronic folders for future retrieval. There are several optical character recognition (OCR) products, both open source and commercial, that help in extracting raw text from the documents in electronic formats. However, existing products do not provide information extraction capability from the raw text. There are other products in the market that attempt to extract specific information entities from small documents, like invoice, shopping receipt, etc., but these solutions are extremely specific and cater to documents with fixed template formats. These solutions are inherently incapable of processing large unstructured documents such as Credit Agreements. Furthermore, current methods use text classifiers which use visual cues, such as bold text, italicized text, font sizes, etc, or position of information, such as left alignment or right alignment to the page in order to identify important text. A completely new approach is required to extract information from such large unstructured/semi-structured documents.

An objective of the present invention is to provide a new state-of-the-art artificial intelligence (AI) Natural Language Processing (NLP) driven software system and method to review, label, query, interpret, and extract information from a document leveraging dynamically constructed outline from raw text of the document that has been converted into an electronic format by scanning or is available in electronic formats like PDF, Word, Images, etc. The present invention can review, label, query, interpret, and extract information from essentially any type of documentation or format of documents.

### BRIEF DESCRIPTION OF THE DRAWINGS

FIG. 1 is a diagram illustrating the computing system of the present invention.

FIG. 2 is a diagram illustrating the computing system that includes at least one personal computing (PC) device.

FIG. 3 is a diagram illustrating the computing system that includes at least one remote server and at least one PC device.

FIG. 4 is a flowchart illustrating the overall process for the method of the present invention.

FIG. 5 is a flowchart illustrating the subprocess for reviewing and correcting the linguistically-important texts.

FIG. 6 is a flowchart illustrating the subprocess for training the learning model.

FIG. 7 is a flowchart illustrating the subprocess for identifying the linguistically-important texts with the learning model.

FIG. 8 is a flowchart illustrating the subprocess identifying the outline headings with the heading classifier.

FIG. 9 is a flowchart illustrating the subprocess for organizing the outline headings into the document outline with the hierarchy classifier.

FIG. 10 is a flowchart illustrating the subprocess of a local embodiment of the computing system.

FIG. 11 is a flowchart illustrating the subprocess of a remote application embodiment of the computing system.

FIG. 12 is a flowchart illustrating the subprocess for identifying and outputting a categorized entity list.

FIG. 13 is a flowchart illustrating the subprocess of reviewing and correcting the plurality of extractable entities.

FIG. 14 is a flowchart illustrating the subprocess of training the learning model to identify extractable entities.

FIG. 15 is a flowchart illustrating the subprocess of identifying the extractable entities with the learning model.

FIG. 16 is a flowchart illustrating the subprocess of identifying the extractable entities using the document outline and the hierarchical structure.

FIG. 17 is a flowchart illustrating the subprocess of a local embodiment of the computing system to output the categorized entity list.

FIG. 18 is a flowchart illustrating the subprocess of a remote application embodiment of the computing system to output the categorized entity list.

### DETAIL DESCRIPTIONS OF THE INVENTION

All illustrations of the drawings are for the purpose of describing selected versions of the present invention and are not intended to limit the scope of the present invention.

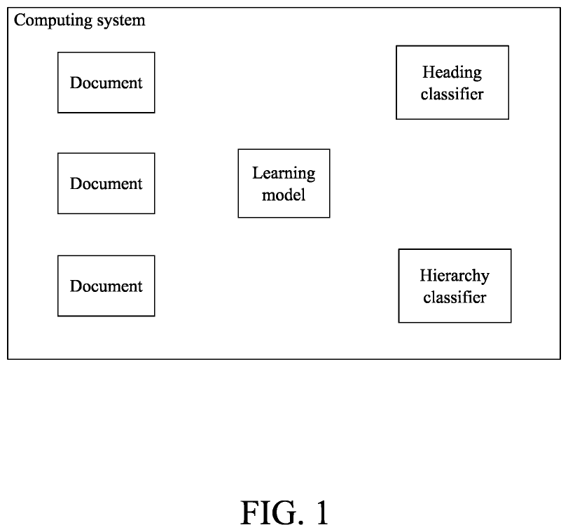

In reference to FIGS. 1 through 18, the present invention is a method for extracting and organizing information from a document. With reference to FIG. 1, the present invention includes at least one computing system (Step A). The computing system may include at least one personal computing (PC) device, at least one remote server, and any combinations thereof dependent on the graphics processing unit (GPU) for performance. In more detail, the method of the present invention is primarily processed through the GPU of a computing device, and therefore, if the GPU of a PC device of a user does not meet the minimum requirements, it is recommended that the user remotely access a sufficient PC device offered through an application service of the present invention. A plurality of documents is stored on the computing system if the computing system is a PC device of a user or the plurality of documents is accessed by the computing system if the user uploads the plurality of documents onto the application service of the present invention. Additionally, each of the plurality of documents may be in any format such as, but not limited to, portable document format (PDF), Microsoft word, portable network graphics (PNG), or hypertext markup language (HTML). Moreover, if a document from the plurality of documents is in physical format, the user may scan the document and convert the document into an electronic format.

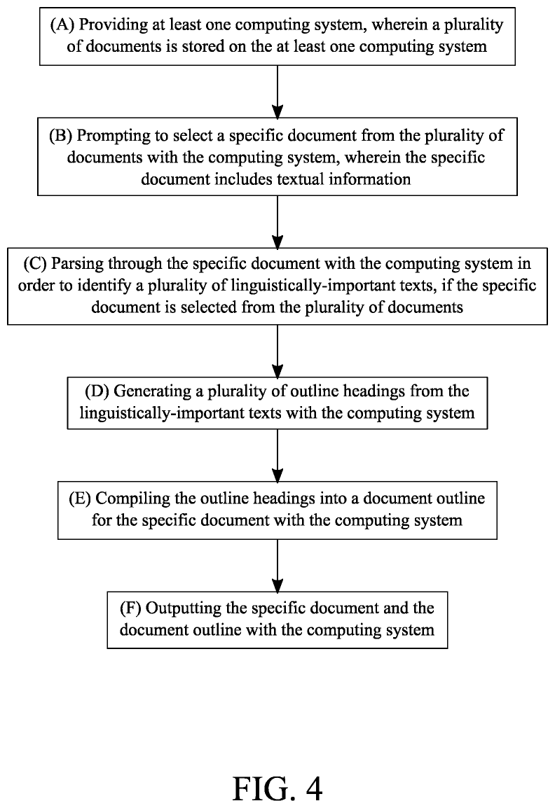

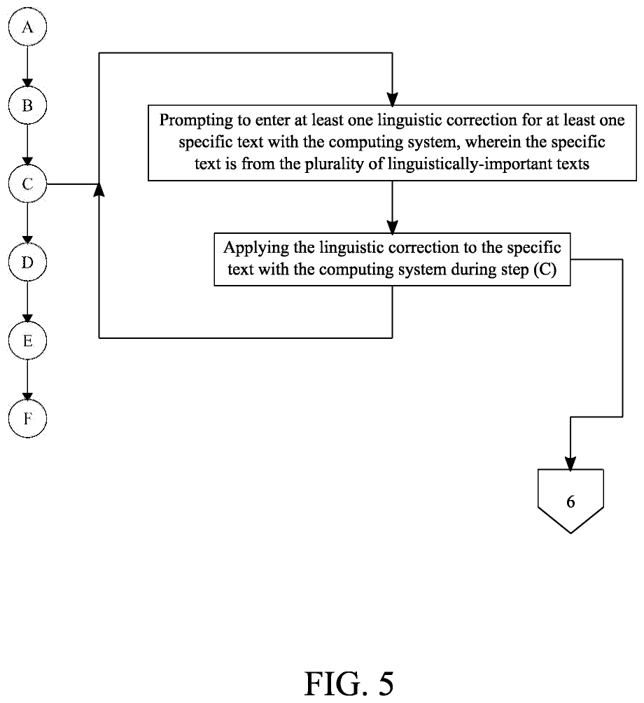

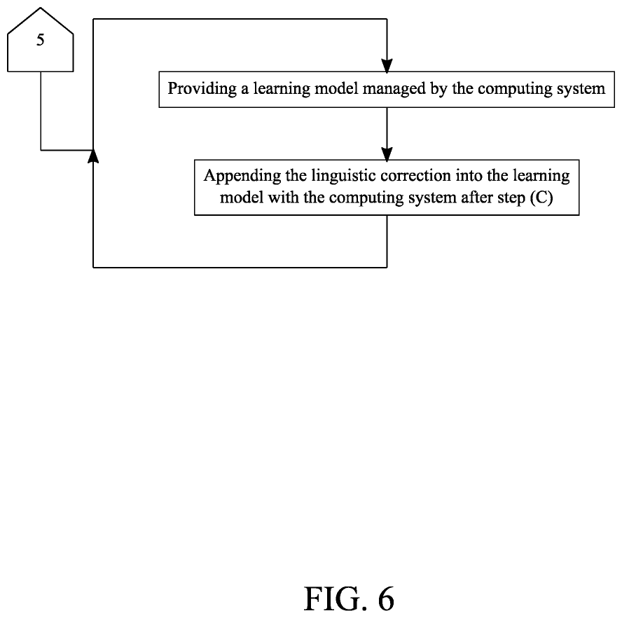

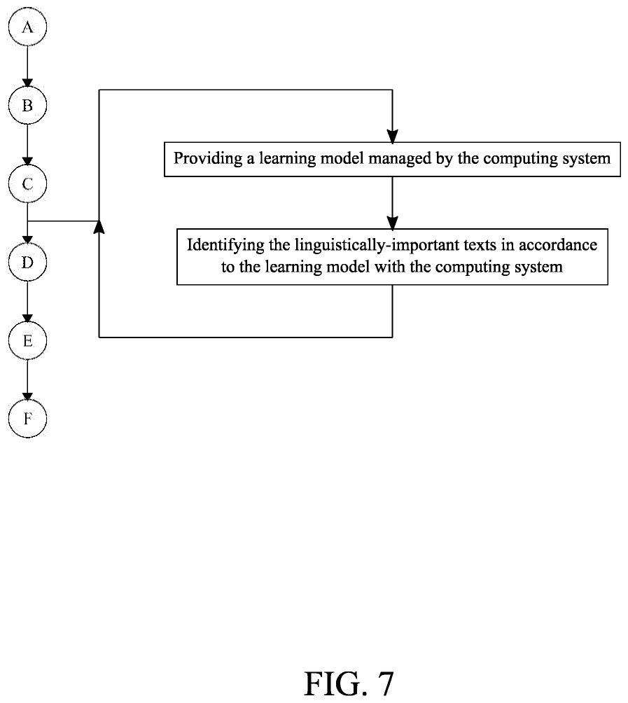

The method of the present invention follows an overall process for extracting and organizing information from a document. With reference to FIG. 4, the computing system prompts to select a specific document from the plurality of documents with the computing system (Step B). The specific document includes textual information which may be in the format of standalone text, text cells in a table, or similar. In more detail, the user is provided the option to choose a document to undergo the process of the present invention. The computing system parses through the specific document in order to identify of a plurality of linguistically-important texts if the specific document is selected from the plurality of documents (Step C). The linguistically-important texts is a set of texts that include important contextual, grammatical, and syntactical features which suggest that the linguistically-important texts may represent main topics and/or subtopics of the specific document or a heading in a table cell. In more detail, the computing system utilizes optical character recognition (OCR) to extract linguistically-important texts from the specific document. Depending on the OCR software/service employed, the linguistically-important texts can be at a character level or at a word level. For certain documents, the linguistically-important texts can be easily extracted by using corresponding software application programming interface (API). The computing system then generates a plurality of outline headings from the linguistically-important texts (Step D). In more detail, the computing infers which linguistically-important texts may represent main topics and/or subtopics of the specific document or table cell headings and labels them as the outline headings. Subsequently, the computing system compiles the outline headings into a document outline for the specific document (Step E). In more detail, the computing system organizes the outline headings based on importance into the document outline. Finally, the computing system outputs the specific document and the document outline (Step F). In more detail, the user is able to view the specific document as standard procedure and is able to view the document outline in order to easily navigate the specific document. Further, the document outline can be readily accessed by clicking on a tab feature of the specific document and the document outline is interactive, and thus, when clicking on a heading or subheading of the document outline, the computing system directs the user to a corresponding portion of the specific document. In order to train the computing system with identifying outline headings and with reference to FIG. 5, the following subprocess is executed. The computing system prompts to enter at least one linguistic correction for at least one specific text. The specific text is from the plurality of linguistically-important texts. In more detail, the computing system displays the linguistically-important texts to the user and the user is provided the option to review and make corrections to the linguistically-important texts. Further, the linguistic correction may be a manual label made by the user that identifies at least one of the linguistically-important texts as an outline heading. The computing system then applies the linguistic correction to the specific text during Step C. Thus, the computing system is trained in identifying outline headings. Furthermore and with reference to FIG. 6, what is specifically being trained is a learning model managed by the computing system. The computing system appends the linguistic correction into the learning model after Step C. With reference to FIG. 7, this allows the computing system to more accurately identify the linguistically-important texts in accordance to the learning model in a current use or future uses. Therefore, the computing system can more accurately generate the plurality of outline headings from the plurality of linguistically-important texts.

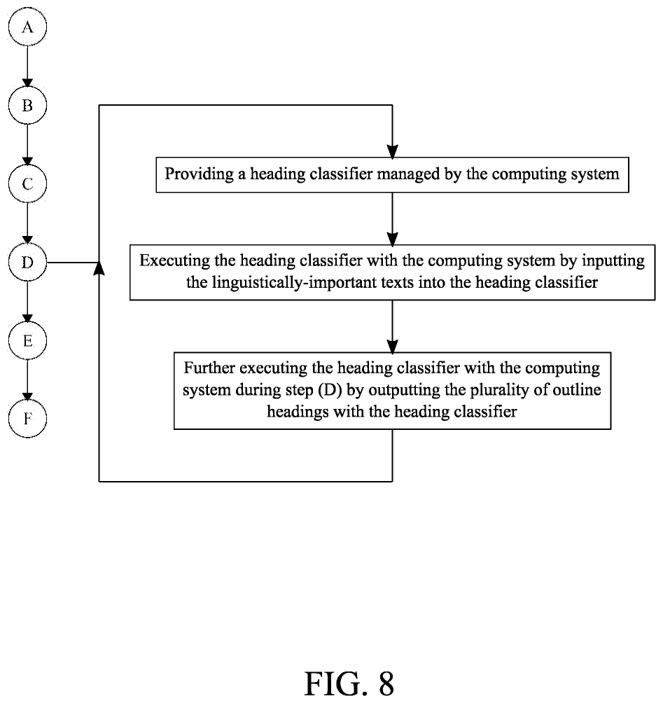

In order to effectively generate the plurality of outline headings from the plurality of linguistically-important texts and with reference to FIG. 8, the following subprocess is executed. A heading classifier is managed by the computing system. The heading classifier is a type of text classifier that is used to separate headings from non-headings. The computing system executes the heading classifier by inputting the linguistically-important texts into heading classifier. In more detail, the heading classifier uses the linguistically-important texts from OCR output and programmatically stitches the linguistically-important texts together into discrete pieces of text called paragraphs. If a paragraph contains multiple sentences, then the paragraph is broken into individual sentences. Each sentence is fed into a language model pre-trained on the domain corpus.

In absence of domain specific language model, a publicly available natural language model pre-trained on a general language corpus, such as Wikipedia for English, can be used. The natural language model encodes the input sentence in a dense vector representation which encapsulates the contextual, grammatical, and syntactical features of the sentence. It is important to note that no visual cues, such as bold text, italicized text, font sizes, etc, or position of information, such as left alignment or right alignment to the page, is used in creating the feature vector. The encoded vector is then fed into a neural net “binary” classification layer, which is fine-tuned along with the language model to train the complete classification model. The computing system further executes the heading classifier during Step D by outputting the plurality of outline headings with the heading classifier. In more detail, the heading classifier predicts the plurality of outline headings by separating the linguistically-important texts into headings or non-headings.

In addition, there are multiple advantages to the heading classifier. The approach is completely independent of the formatting in a document and the computing system performs regardless of the visual formatting in a document. The heading classifier predicts headings even if there are no text visually marked as such through formatting. Also, the present invention does not assume presence of any specific section like a table of content. The present invention works purely based on the text in the document and their grammatical, contextual, and syntactical structure that is encoded into a dense vector representation using a pre-trained natural language model. The present invention has no association with any specific section in the document.

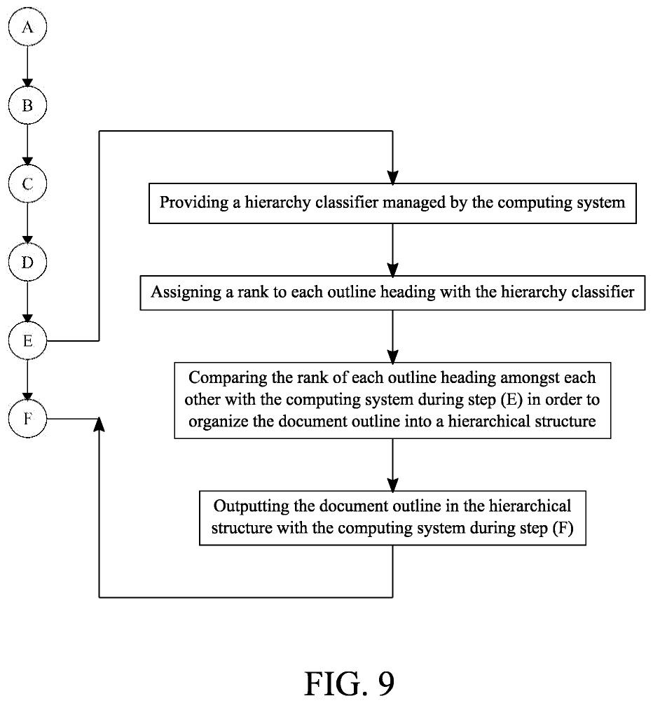

In order to effectively organize the plurality of outline headings into the document outline and with reference to FIG. 9, the following subprocess is executed. A hierarchy classifier is managed by the computing system. The hierarchy classifier assigns a rank to each outline heading. In more detail, starts with adjacent headings from the heading classifier. The hierarchy classifier pairs the plurality of outline headings for a multi-class classification. Each heading pair is encoded into a dense vector leveraging a natural language model pre-trained on the domain corpus. In absence of domain specific language model, publicly available natural language model pre-trained on general language corpus such as Wikipedia for English, can be used. The natural language model encodes the input sentence in a dense vector representation which encapsulates the contextual, grammatical, and syntactical features of the sentence. The encoded vector is then fed into a neural net “multi-class” classification layer, which is fine-tuned along with the language model to train the complete classification model. Manual labels of heading texts as parent, child, or sibling are provided for model training. Once the model is trained through the neural net “multi-class” classification layer, untagged heading texts or sentences are fed to the classification model for prediction. The computing system then compares the rank of each outline heading amongst each other during Step E in order to organize the document outline into a hierarchical structure. In more detail, the predictions from the classification model are then used to tag the heading as either a parent of the other heading in the pair, both headings at the same level (sibling), or child of the other heading in the pair. Note that table headings are not considered in this classification. It is assumed that headings in table are single level. Theoretically, the method can be extended to any language or domain with a natural language model pre-trained for that particulate language and/or domain. Finally, the computing system outputs the document outline in the hierarchical structure during Step F. Thus, the plurality of outline headings is organized into the document outline.

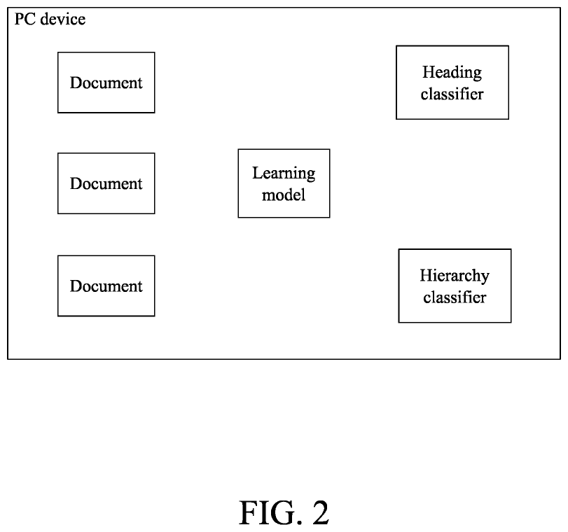

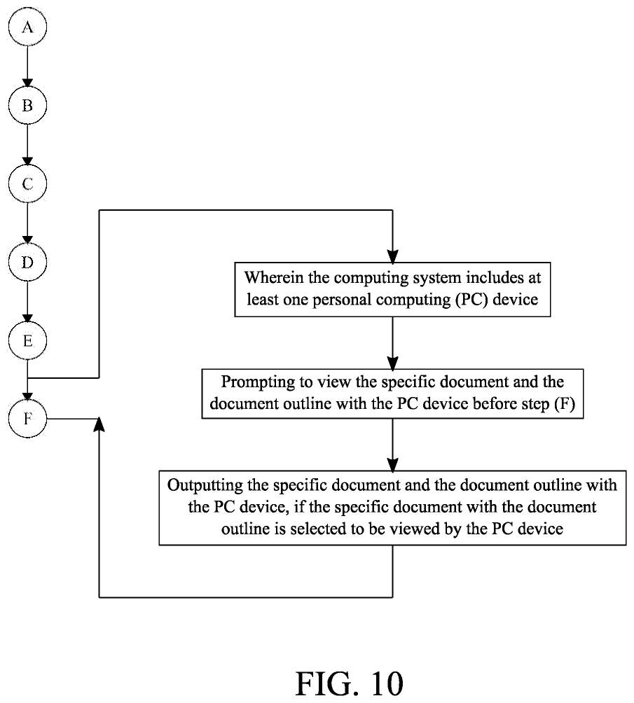

In a local embodiment of the present invention and if a PC device of a user includes a sufficient GPU and with reference to FIGS. 2 and 10, the following subprocess is executed. The computing system includes at least one PC device. The PC device may be any type of computing device that includes a sufficient GPU such as, but not limited to, a desktop computer, a notebook computer, or a mobile tablet. The PC device prompts to view the specific document and the document outline before Step F. In more detail, the user is provided the option to view the specific document and the document outline. The PC device outputs the specific document and the document outline if the specific document and the document outline is selected to be viewed by the PC device.

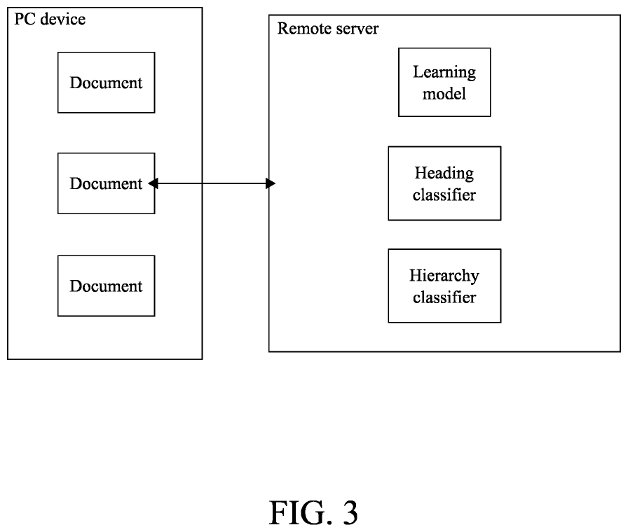

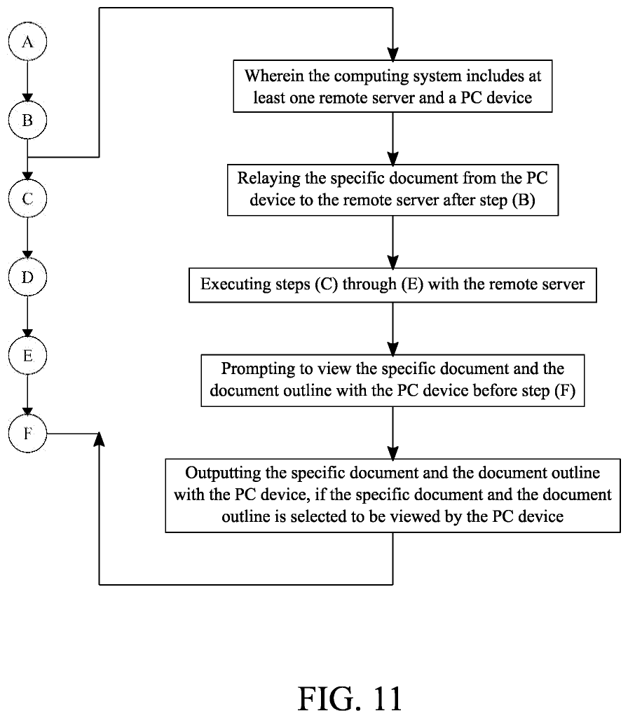

In a remote application embodiment of the present invention and with reference to FIGS. 3 and 11, the following subprocess is executed. The computing system includes at least one remote server and a PC device. The remote server is a cloud server used to process and manage information provided by the user. The PC device may be any type of computing device such as, but not limited to, a desktop computer, a notebook computer, a smartphone, or a mobile tablet. The specific document is relayed from the PC device to the remote server after Step B. In more detail, the plurality of documents is stored on the PC device and the user can choose to upload one of the plurality of documents onto the remote server. The remote server executes Steps C through Step E. In more detail, the remote server process the specific document in order to output the document outline due to the remote server including a sufficient GPU rather than the PC device in this embodiment. The PC device prompts to view the specific document and the document outline before Step F. In more detail, the user is provided the option to view the specific document and the document outline. The PC device outputs the specific document and the document outline if the specific document and the document outline is selected to be viewed by the PC device.

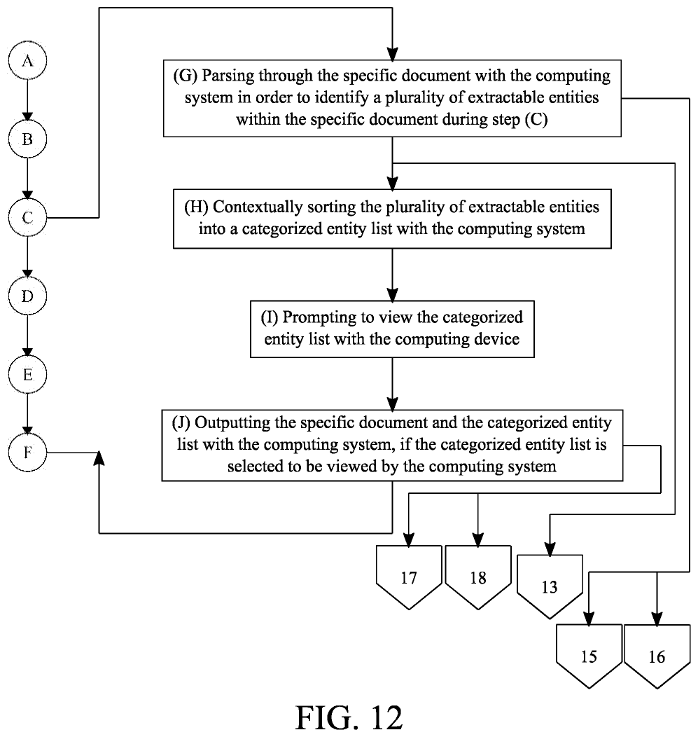

With reference to FIG. 12, the following subprocess is another feature of the present invention which outputs a categorized entity list. The computing system parses through the specific document in order to identify a plurality of extractable entities within the specific document during Step C (Step G). The plurality of extractable entities is a set of entities that may include, but is not limited to, important pronouns, important dates, or important clauses. Further, there are multiple methods that can be used to identify the plurality of extractable entities. The computing system then contextually sorts the plurality of extractable entities into a categorized entity list (Step H). In more detail, the computing system organizes the plurality of extractable entities based on relevancy. The computing device prompts the view the categorized entity list (Step I). In more detail, the user is provided the option to view categorized entity list. Further, the user can choose to view the categorized entity list by clicking on a corresponding tab. Finally, the computing system the specific document and the document outline if the categorized entity list is selected to be viewed by the computing system. In more detail, the categorized entity list can be displayed along the specific document. Further, the user can switch from viewing the categorized entity list and the document outline by clicking on the corresponding tab for each.

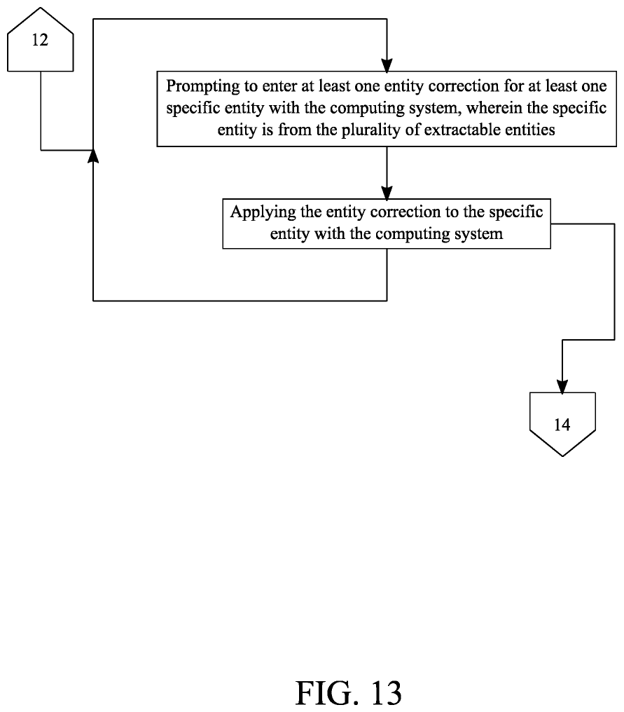

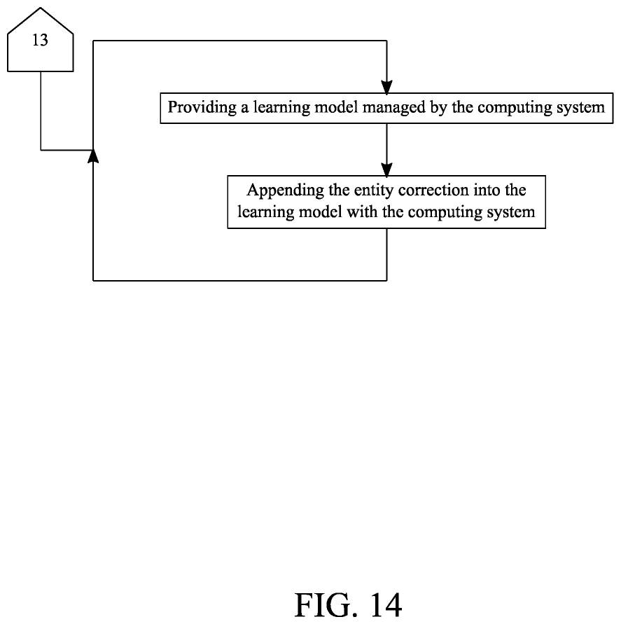

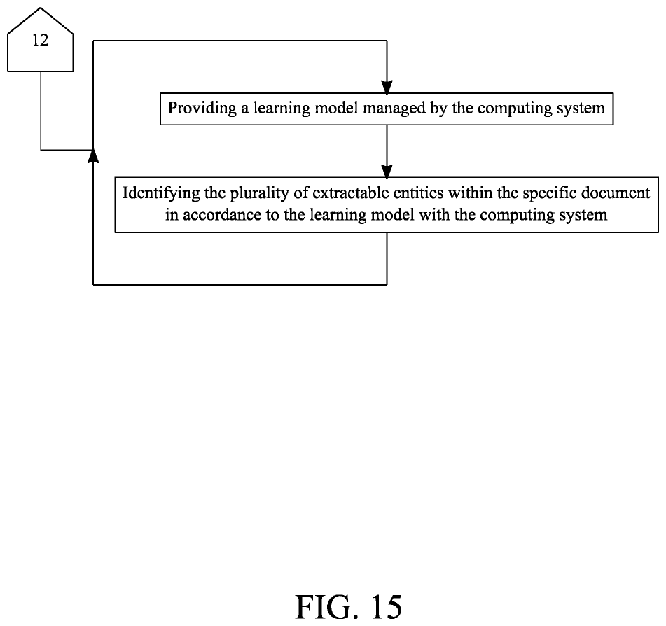

In order to train the computing system with identifying the plurality of extractable entities and with reference to FIG. 13, the following subprocess is executed. The computing system prompts to enter at least one entity correction for at least one specific entity. The specific entity is from the plurality of extractable entities. In more detail, the computing system displays the plurality of extractable entities to the user and the user is provided the option to review and make corrections to the plurality of extractable entities. The computing system then applies the entity correction to the specific entity. Thus, the computing system is trained in identifying the plurality of extractable entities. Furthermore and with reference to FIG. 14, what is specifically being trained is the learning model managed by the computing system. The computing system appends the entity correction into the learning model. With reference to FIG. 15, this allows the computing system to more accurately identify the plurality of extractable entities in accordance to the learning model in future in a current use or future uses.

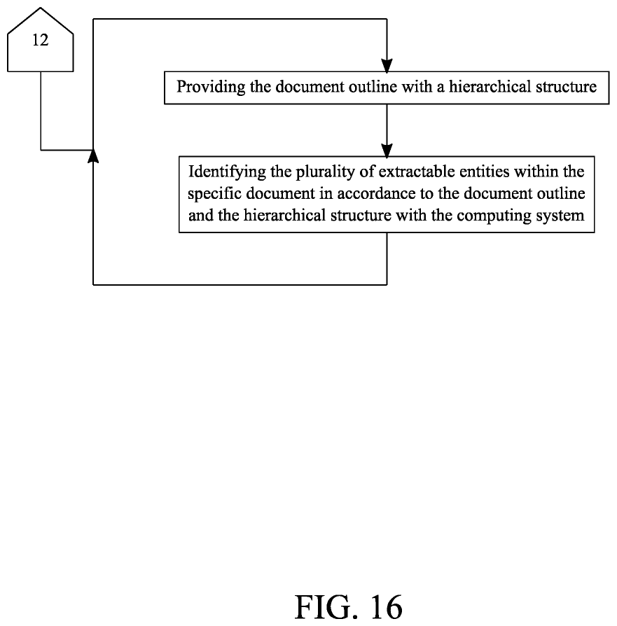

As mentioned previously, there are multiple methods that can be used to identify the plurality of extractable entities. With reference to FIG. 16, the computing system identifies the plurality of extractable entities within the specific document in accordance to the document outline and the hierarchical structure. In more detail, the computing system then navigates through the document outline with the hierarchical structure for each entity based on pre-defined configuration to search for the section with the highest likelihood of finding any entity information in the associated section contents such as paragraphs, data tables, etc. It is possible that computing system may choose to scan the entire document (regardless of the hierarchical structure) for an entity based on the configuration. The text from the identified sections (or the sections across entire document as the case may be) then have four possible options in which occurs. The first, the text from the identified sections is inputted into a natural language model-based token classifier that predicts which token(s) are most relevant for an entity. Secondly, the text can possibly be encoded in a dense vector leveraging natural language model and determine similarity with pre-defined text in entity configuration to choose most suitable option available in the pre-defined list of options for an entity. Thirdly, the text may leverage a proprietary natural language model-based search algorithm to identify data items in a table for an entity as per the configuration. Or lastly, the text from the identified sections feed the question(s), as specified in the pre-defined configuration for an entity, and text(s) as context to a NLP-based question answering model to determine the most appropriate answer to the question in the given context.

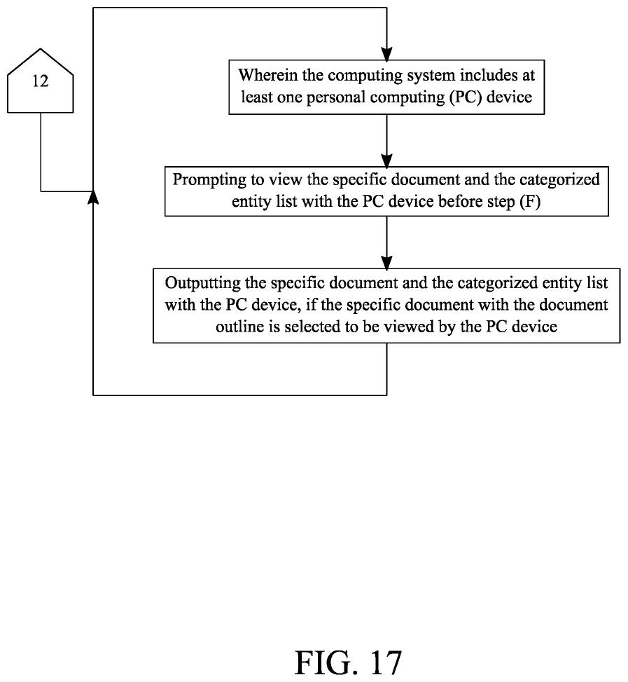

In a local embodiment of the present invention and if a PC device of a user includes a sufficient GPU and with reference to FIGS. 2 and 17, the following subprocess is executed. The computing system includes at least one PC device. The PC device may be any type of computing device that includes a sufficient GPU such as, but not limited to, a desktop computer, a notebook computer, or a mobile tablet. The PC device prompts to view the specific document and the categorized entity list before Step J. In more detail, the user is provided the option to view the specific document and the categorized entity list. The PC device outputs the specific document and the categorized entity list if the specific document and the categorized entity list is selected to be viewed by the PC device.

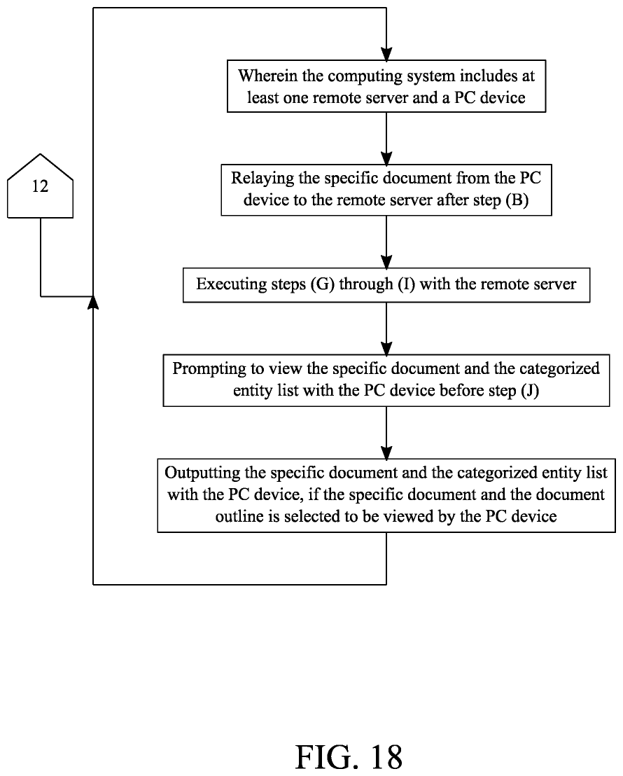

In a remote application embodiment of the present invention and with reference to FIGS. 3 and 18, the following subprocess is executed. The computing system includes at least one remote server and a PC device. The remote server is a cloud server used to process and manage information provided by the user. The PC device may be any type of computing device such as, but not limited to, a desktop computer, a notebook computer, a smartphone, or a mobile tablet. The specific document is relayed from the PC device to the remote server after Step B. In more detail, the plurality of documents is stored on the PC device and the user can choose to upload one of the plurality of documents onto the remote server. The remote server executes Steps G through Step I. In more detail, the remote server process the specific document in order to output the categorized entity list due to the remote server including a sufficient GPU rather than the PC device in this embodiment. The PC device prompts to view the specific document and the categorized entity list before Step J. In more detail, the user is provided the option to view the specific document and the categorized entity list. The PC device outputs the specific document and the categorized entity list if the specific document and the categorized entity list is selected to be viewed by the PC device.

It is important to know that the learning model has been pre-trained using unsupervised techniques, such as embeddings, global vectors (GloVe), transformer-based architectures like BERT, etc., on a corpus. The corpus could be domain specific or general language such as Wikipedia articles, news articles, etc. for the English language.

Natural language models are language specific and can be trained for any language with necessary pre-processing adhering to the model specifications. Once a language model is trained, it can be used for a variety of tasks with fine-tuning. Fine-tuning is a supervised training activity, where specific labels are provided along with the input to fine-tune the model for a specific task such as classification, question & answering, translation, etc.

The present invention is used (in other words, presented to the user) through a graphical user interface (GUI) that provides the user with the functionality to easily navigate a document using the assembled document outline. The document outline has clickable reference links to various sections in a document that make it easier for the user to quickly navigate to the section of interest in the document and mark/label/review/correct heading predictions from the computing system.

The GUI also provides the categorized entity list to the user for review and confirmation. Each of the extractable entities listed is clickable, and the user can navigate to the location in a document simply by clicking on the extractable entity on the sidebar presenting the document outline. If necessary, any correction can be easily applied by clicking on the entity to unmark the desired entity then making a new selection.

All extracted entity information along with configuration and the outline headings can be saved by clicking the save button. If necessary, the saved data can be retrieved by the computing system that can be reviewed, amended, and saved again by the user. The present invention is industry/domain agnostic and can be adapted to any relevant use case. Once the learning models is trained for the domain, either through one-time upfront training or incremental training as documents are labeled for various entities, the present invention will be equally applicable across industries.

The table search feature of the present invention can be used for transferring data from one table format to another table format. An example will be “financial spreading” where balance sheet and income statement data for a business entity is ported into internal spreadsheet structure for credit analysis. Another example is to simply convert a data table presented in a document to an excel sheet.

The present invention can also be used to selectively port sections of document from one document to another document. For example, the need for changing a document template, the text needs to be ported selectively from the old template into a new template for relevant similar sections in the new template.

Furthermore, the present invention can also be used for simple reverse engineering of documents from PDF and images format for editing in a word processor like a word document. Thus, avoiding the need of manually typing the content from non-editable formats into an editable format. For example, converting a non-editable PDF file into an editable Microsoft Word document.

The present invention is designed to run on specialized hardware like graphic processing units (GPUs), tensor processing units (TPUs), and accelerators, such as P100, V100, etc., to accelerate mathematical computations for better performance. The underlying encoding models (like BERT, Roberta, XLNET, etc.) are based on latest

Transformer technology that are inherently computationally intensive and require specialized equipment for efficient model training and inference steps.

The present invention effectively imparts cognitive abilities to a piece of computing hardware that can perform functions like humans to navigate through the document and locate relevant document sections to extract information (i.e. entities, specific text as answer to a question, etc.).

Although the invention has been explained in relation to its preferred embodiment, it is to be understood that many other possible modifications and variations can be made without departing from the spirit and scope of the invention as hereinafter claimed.

What is claimed is:

1. A method for extracting and organizing information from a document, the method comprising the steps of:
(A) providing at least one computing system, wherein a plurality of documents is stored on the at least one computing system;
(B) prompting to select a specific document from the plurality of documents with the computing system, wherein the specific document includes textual information;
(C) parsing through the specific document with the computing system in order to identify a plurality of linguistically-important texts, if the specific document is selected from the plurality of documents;
(D) generating a plurality of outline headings from the linguistically-important texts with the computing system;
(E) compiling the outline headings into a document outline for the specific document with the computing system; and
(F) outputting the specific document and the document outline with the computing system.

2. The method for extracting and organizing information from a document, the method as claimed in claim 1 comprising the steps of:
prompting to enter at least one linguistic correction for at least one specific text with the computing system, wherein the specific text is from the plurality of linguistically-important texts; and
applying the linguistic correction to the specific text with the computing system during step (C).

3. The method for extracting and organizing information from a document, the method as claimed in claim 2 comprising the steps of:
providing a learning model managed by the computing system; and
appending the linguistic correction into the learning model with the computing system after step (C).

4. The method for extracting and organizing information from a document, the method as claimed in claim 1 comprising the steps of:
providing a learning model managed by the computing system;
identifying the linguistically-important piece texts in accordance to the learning model with the computing system;

5. The method for extracting and organizing information from a document, the method as claimed in claim 1 comprising the steps of:
providing a heading classifier managed by the computing system;
executing the heading classifier with the computing system by inputting the linguistically-important texts into the heading classifier; and
further executing the heading classifier with the computing system during step (D) by outputting the plurality of outline headings with the heading classifier.

6. The method for extracting and organizing information from a document, the method as claimed in claim 1 comprising the steps of:
providing a hierarchy classifier managed by the computing system;
assigning a rank to each outline heading with the hierarchy classifier;
comparing the rank of each outline heading amongst each other with the computing system during step (E) in order to organize the document outline into a hierarchical structure; and
outputting the document outline in the hierarchical structure with the computing system during step (F).

7. The method for extracting and organizing information from a document, the method as claimed in claim 1 comprising the steps of:
wherein the computing system includes at least one personal computing (PC) device;
prompting to view the specific document and the document outline with the PC device before step (F); and
outputting the specific document and the document outline with the PC device, if the specific document with the document outline is selected to be viewed by the PC device.

8. The method of monitoring spoilage conditions of a product, the method as claimed in claim 1 comprises the steps of:
wherein the computing system includes at least one remote server and a PC device;
relaying the specific document from the PC device to the remote server after step (B);
executing steps (C) through (E) with the remote server;
prompting to view the specific document and the document outline with the PC device before step (F); and
outputting the specific document and the document outline with the PC device, if the specific document and the document outline is selected to be viewed by the PC device.

9. The method for extracting and organizing information from a document, the method as claimed in claim 1 comprising the steps of:
(G) parsing through the specific document with the computing system in order to identify a plurality of extractable entities within the specific document during step (C);
(H) contextually sorting the plurality of extractable entities into a categorized entity list with the computing system;
(I) prompting to view the categorized entity list with the computing system; and
(J) outputting the specific document and the categorized entity list with the computing system, if the categorized entity list is selected to be viewed by the computing system.

10. The method for extracting and organizing information from a document, the method as claimed in claim 9 comprising the steps of:
prompting to enter at least one entity correction for at least one specific entity with the computing system, wherein the specific entity is from the plurality of extractable entities; and
applying the entity correction to the specific entity with the computing system.

11. The method for extracting and organizing information from a document, the method as claimed in claim 10 comprising the steps of:
providing a learning model managed by the computing system; and
appending the entity correction into the learning model with the computing system.

12. The method for extracting and organizing information from a document, the method as claimed in claim 9 comprising the steps of:
providing a learning model managed by the computing system; and
identifying the plurality of extractable entities within the specific document in accordance to the learning model with the computing system.

13. The method for extracting and organizing information from a document, the method as claimed in claim 9 comprising the steps of:
providing the document outline with a hierarchical structure; and
identifying the plurality of extractable entities within the specific document in accordance to the document outline and the hierarchical structure with the computing system.

14. The method for extracting and organizing information from a document, the method as claimed in claim 9 comprising the steps of:
wherein the computing system includes at least one personal computing (PC) device;
prompting to view the specific document and the categorized entity list with the PC device before step (J); and
outputting the specific document and the categorized entity list with the PC device, if the specific document and the categorized entity list is selected to be viewed by the PC device.

15. The method of monitoring spoilage conditions of a product, the method as claimed in claim 9 comprises the steps of:
wherein the computing system includes at least one remote server and a PC device;
relaying the specific document from the PC device to the remote server after step (B);
executing steps (G) through (I) with the remote server;
prompting to view the specific document with the categorized entity list with the PC device before step (J); and
outputting the specific document and the categorized entity list with the PC device, if the specific document and the categorized entity list is selected to be viewed by the PC device.
